(19) United States
(12) Patent Application Publication
(10) Pub. No.: US 2021/0240446 A1
(43) Pub. Date: Aug. 5, 2021

(54) METHOD FOR IDENTIFYING CARRIER MOTION MODE BASED ON TIME-DOMAIN DIFFERENTIAL CHARACTERISTIC

(71) Applicant: Zhejiang University, Hangzhou City (CN)

(72) Inventors: Lijun MIAO, Hangzhou City (CN); Jingtao YAN, Hangzhou City (CN); Yilan ZHOU, Hangzhou City (CN); Tengchao HUANG, Hangzhou City (CN); Shuangliang CHE, Hangzhou City (CN); Xiaowu SHU, Hangzhou City (CN)

(73) Assignee: Zhejiang University, Hangzhou City (CN)

(21) Appl. No.: 17/151,052

(22) Filed: Jan. 15, 2021

(30) Foreign Application Priority Data
Jan. 16, 2020 (CN) 202010049834.7

(51) Int. Cl. G06F 7/64; G06F 7/523

(52) U.S. Cl. CPC G06F 7/64; G06F 7/523

(57) ABSTRACT

The present disclosure provides a method for identifying a carrier motion mode based on a time-domain differential characteristic. Firstly, a difference operation is performed on data to obtain a difference sequence, and then sign, progressive multiplication, and accumulation operations are performed on the difference sequence, and finally thresholds are set to determine an accumulation sequence, so as to obtain a carrier motion mode. All operations involved in this method are performed in time domain, and the method has the advantages of simple algorithm, good real-time performance, accurate determination, and strong robustness.

### TECHNICAL FIELD

The present disclosure relates to the field of intelligent sensing, and in particular, to a method for identifying a carrier motion mode based on a time-domain differential characteristic.

### BACKGROUND

With the rapid development of the electronic information technology, photoelectric detection technology, and artificial intelligence technology, the smart industry represented by wearable devices, smart homes, smart manufacturing, mobile robots, and unmanned driving has developed vigorously. Intelligent instruments and modern sensors are the hardware foundation and basic guarantee for the smart industry to thrive. Real-time monitoring of motion modes is essential for many intelligent applications. In a highly dynamic and unpredictable marine environment, to improve the safety of an unmanned surface vehicle and the reliability of its mission, it is necessary to monitor a motion mode of the unmanned surface vehicle in real time. In an unmanned driving system or an adaptive cruise system of a vehicle, real-time and reliable motion mode monitoring helps to detect a problem accurately upon occurrence, and guide the system or a driver to solve the problem in time to ensure driving safety. In the field of industrial inspection or safety, real-time identification of sensor modes helps to discover existing defects and potential faults accurately, to ensure product quality and production safety. Even in small devices like smartphones and smart bands, a micro accelerometer and a micro-gyroscope can be built in to detect paces based on motion mode changes, which can minimize cheating and improve the accuracy of pace counting. Therefore, identification of motion modes is a core technology for in-depth development and wide application of the smart industry. The present disclosure provides a method for identifying a carrier motion mode based on a time-domain differential characteristic, which can well meet an application requirement for fast and accurate real-time identification of a carrier motion mode.

### SUMMARY

To overcome the shortcomings of the prior art, the present disclosure provides a method for identifying a carrier motion mode based on a time-domain differential characteristic, to achieve simple, efficient, and accurate real-time identification of a carrier motion mode by analyzing and calculating a time-domain differential characteristic of carrier motion data.

An algorithm for the method for identifying a carrier motion mode based on a time-domain differential characteristic is as follows:

1) assuming that a data sequence collected in a period of time is xi (i=1, . . . , k), performing a difference operation on the sequence xi to obtain a sequence di (i=1, . . . , k);

2) applying a sign function on the sequence di to obtain a sequence si (i=1, . . . , k), and performing progressive multiplication on the sign sequence to obtain a sequence gi (i=1, . . . , k);

3) defining a positive integer N, and performing an accumulation operation on the sequence gi with length N to obtain a sequence zi (i=1, . . . , k); and

4) setting thresholds T1 and T2 based on a value of N, and performing motion mode identification.

A calculation method of the difference sequence in step 1) is:

$${d}_{i} = \{ \begin{matrix}{x}_{i} - {x}_{1} , & i < m \\ {x}_{i} - {x}_{i - m + 1} , & k \geq i \geq m\end{matrix}$$

where, a value of m ranges from 2 to 10.

The sign operation in step 2) is:

$${s}_{i} = \{ \begin{matrix}0 , & {d}_{i} = 0 \\ \frac{{d}_{i}}{\vert {d}_{i} \vert} , & {d}_{i} \neq 0\end{matrix}$$

The progressive multiplication operation in step 2) is:

$${g}_{i} = \{ \begin{matrix}{s}_{i} {s}_{1} , & i = p \\ {s}_{i} {s}_{i - p + 1} , & k \geq i > p\end{matrix}$$

where, a value of p ranges from 2 to 10.

The accumulation operation in step 3) is:

$${z}_{i} = \{ \begin{matrix}\vert {\sum }_{1}^{i} {g}_{i} \vert , & i < N \\ \vert {\sum }_{i - N + 1}^{i} {g}_{i} \vert , & k \geq i \geq N\end{matrix}$$

where, a value of N ranges from 20 to 80.

The motion mode identification method in step 4) is:

$$Motion mode = \{ \begin{matrix}Dynamic state , {z}_{i} > {T}_{2} \\ Steady state , {z}_{i} < {T}_{1} \\ Stay in original state , {T}_{l} \leq {z}_{i} \leq {T}_{2}\end{matrix}$$

where, values of T1 and T2 are related to N and data characteristics, the values of T1 and T2 range from N/4 to 3N/4, and T1<T2.

Beneficial effects of the present disclosure: Data characteristic analysis is performed on carrier motion data in time domain. This can implement simple, efficient, and accurate real-time identification of a carrier motion mode by using differential characteristics.

### BRIEF DESCRIPTION OF THE DRAWINGS

FIG. 1 is an exemplified signal diagram.

FIG. 2 is an accumulation sequence diagram.

### DETAILED DESCRIPTION

The present disclosure is further described below with reference to the accompanying drawings and embodiments.

An algorithm for a method for identifying a carrier motion mode based on a time-domain differential characteristic is as follows:

1) assuming that a data sequence collected in a period of time is xi (i=1, . . . , k), performing a difference operation on the sequence xi to obtain a sequence di (i=1, . . . , k);

2) applying a sign function on the sequence di to obtain a sequence si (i=1, . . . , k), and performing progressive multiplication on the sign sequence to obtain a sequence gi (i=1, . . . , k);

3) defining a positive integer N, and performing an accumulation operation on the sequence gi with length N to obtain a sequence zi (i=1, . . . , k); and

4) setting thresholds T1 and T2 based on a value of N, and performing motion mode identification.

A carrier motion may be a linear or angular motion, and corresponding data may be output of an accelerometer or a gyroscope. The motion mode includes a steady state and a dynamic state. The steady state means that a carrier moves with constant velocity or angular velocity, and the dynamic state means that velocity or angular velocity of a carrier changes with a specific law.

A calculation method of the difference sequence in step 1) is:

$${d}_{i} = \{ \begin{matrix}{x}_{i} - {x}_{1} , & i < m \\ {x}_{i} - {x}_{i - m + 1} , & k \geq i \geq m\end{matrix}$$

A value of m ranges from 2 to 10. The value of m may not be too large, to avoid an error of mode identification caused by drift.

The sign operation in step 2) is:

$${s}_{i} = \{ \begin{matrix}0 , & {d}_{i} = 0 \\ \frac{{d}_{i}}{\vert {d}_{i} \vert} , & {d}_{i} \neq 0\end{matrix}$$

The progressive multiplication operation in step 2) is:

$${g}_{i} = \{ \begin{matrix}{s}_{i} {s}_{1} , & i = p \\ {s}_{i} {s}_{i - p + 1} , & k \geq i > p\end{matrix}$$

A value of p ranges from 2 to 10. The value of p may not be too large, to avoid an error of mode identification caused by drift.

The accumulation operation in step 3) is:

$${z}_{i} = \{ \begin{matrix}\vert {\sum }_{1}^{i} {g}_{i} \vert , & i < N \\ \vert {\sum }_{i - N + 1}^{i} {g}_{i} \vert , & k \geq i \geq N\end{matrix}$$

A value of N ranges from 20 to 80. A larger value of N indicates a greater delay of mode identification, poorer real-time performance of a system, but a higher accuracy of identification, and vice versa. The value of N is also related to system data characteristics. If randomness is good, even if the value of N is small, a high identification accuracy can be achieved, and vice versa. Therefore, the value of N needs to be determined based on real-time requirements and data characteristics of the system.

The motion mode identification method in step 4) is:

$$Motion mode = \{ \begin{matrix}Dynamic state , {z}_{i} > {T}_{2} \\ Steady state , {z}_{i} < {T}_{1} \\ Stay in original state , {T}_{1} \leq {z}_{i} \leq {T}_{2}\end{matrix}$$

Values of T1 and T2 are related to N and data characteristics, the values of T1 and T2 range from N/4 to 3N/4, and T1<T2. To reduce a misjudgment rate and improve the robustness of the algorithm, a transition interval is set during the identification. That is, when zi is within [T1, T2], it is determined that the carrier motion mode remains unchanged, until zi is less than T1 or greater than T2 again.

The present disclosure implements data characteristic analysis on carrier motion data in time domain. Through analysis and operation on differential characteristics of the carrier motion data, simple, efficient, and accurate real-time identification of a carrier motion mode can be implemented.

### Embodiment

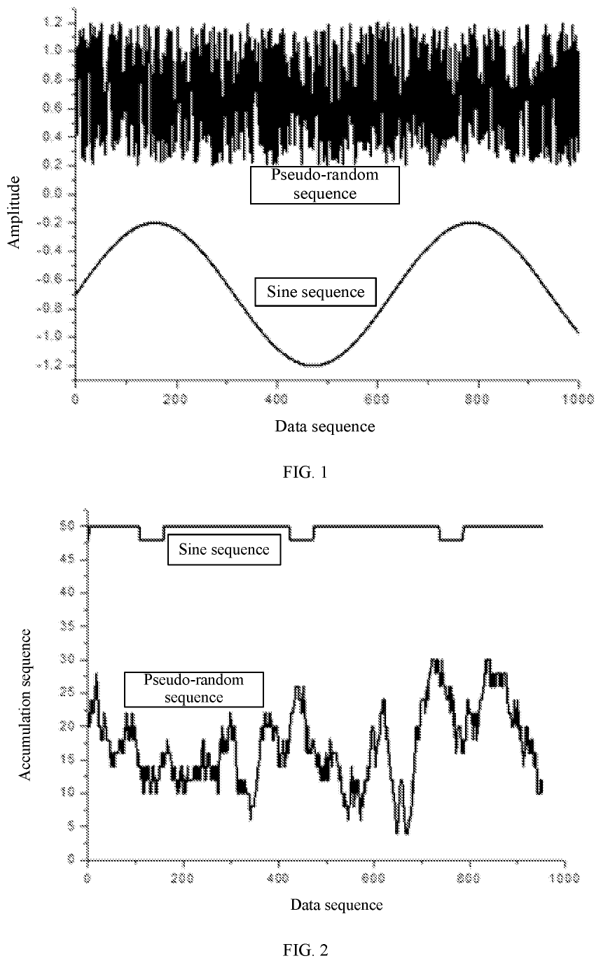

To verify the effect of this method, it is assumed that a pseudo-random sequence as steady state data and a sine sequence as dynamic state data are used as exemplified signals, with a data length of 1000. As shown in FIG. 1, let m=p=2, N=50. A resulting accumulation sequence is shown in FIG. 2. When T1=16.7 and T2=33.3, two motion modes can be easily distinguished from the accumulation sequence.

The implementation solutions in the above description can be further combined or replaced. The implementation solutions merely describe preferred embodiments of the present disclosure, but are not intended to limit the protection scope of the present disclosure. Those of ordinary skill in the art may make various modifications and improvements to the technical solutions in the present disclosure without departing from the essence of the present disclosure. All these modifications and improvements shall fall within the protection scope of the present disclosure. The protection scope of the present disclosure is defined by the appended claims and their equivalents.

1-6. (canceled)

7. A method for identifying a carrier motion mode based on a time-domain differential characteristic, said method comprising:
(a) assuming that a data sequence collected in a period of time is xi (i=1, . . . , k), performing a difference operation on the sequence xi to obtain a difference sequence di (i=1, . . . , k);
(b) performing a sign obtaining algorithm on the difference sequence di to obtain a sign sequence si (i=1, . . . , k) and performing a progressive multiplication algorithm on the sign sequence to obtain a sequence gi (i=1, . . . , k);
(c) defining a positive integer N and performing an accumulation algorithm on the sequence gi with length N to obtain a sequence zi (i=1, . . . , k); and
(d) setting thresholds T1 and T2 based on a value of N and performing motion mode identification.

8. The method according to claim 7, wherein said step of performing difference sequence in said step (a) comprises using an algorithm:
$${d}_{i} = \{ \begin{matrix}{x}_{i} - {x}_{1} , & i < m \\ {x}_{i} - {x}_{i - m + 1} , & k \geq i \geq m\end{matrix}$$
wherein a value of m ranges from 2 to 10.

9. The method according to claim 7, wherein said step of performing sign obtaining algorithm in said step (b) comprises using a sign operation algorithm:
$${s}_{i} = \{ \begin{matrix}0 , & {d}_{i} = 0 \\ \frac{{d}_{i}}{\vert {d}_{i} \vert} , & {d}_{i} \neq 0\end{matrix} .$$

10. The method according to claim 7, wherein said step of performing progressive multiplication in said step (b) comprises using a progressive multiplication algorithm:
$${g}_{i} = \{ \begin{matrix}{s}_{i} {s}_{1} , & i = p \\ {s}_{i} {s}_{i - p + 1} , & k \geq i > p\end{matrix}$$
wherein a value of p ranges from 2 to 10.

11. The method according to claim 7, wherein said step of performing accumulation operation in said step (c) comprises using an accumulation operation algorithm:
$${z}_{i} = \{ \begin{matrix}\vert {\sum }_{1}^{i} {g}_{i} \vert , & i < N \\ \vert {\sum }_{i - N + 1}^{i} {g}_{i} \vert , & k \geq i \geq N\end{matrix}$$
wherein a value of N ranges from 20 to 80.

12. The method according to claim 7, wherein said step of identifying motion mode in said step (d) comprises using a motion mode identifying algorithm:
$$Motion mode = \{ \begin{matrix}Dynamic state , {z}_{i} > {T}_{2} \\ Steady state , {z}_{i} < {T}_{1} \\ Stay in original state , {T}_{1} \leq {z}_{i} \leq {T}_{2}\end{matrix}$$
wherein values of T1 and T2 are related to N and data characteristics, the values of T1 and T2 range from N/4 to 3N/4, and T1<T2.
